(19) United States
(12) Patent Application Publication
(10) Pub. No.: US 2009/0194454 A1
(43) Pub. Date: Aug. 6, 2009

(54) Disposable pad with wipes for cleaning pet paws

(76) Inventors: Evelyn P. Wong, Issaquah, WA (US); Cameron F. Wong, Issaquah, WA (US)

Correspondence Address: LITMAN LAW OFFICES, LTD., POST OFFICE BOX 15035, CRYSTAL CITY STATION, ARLINGTON, VA, 22215-0035, US

(21) Appl. No.: 12/068,358

(22) Filed: Feb. 5, 2008

(51) Int. Cl. A01K 13/00; B65D 71/50

(52) U.S. Cl. 206/581; 119/600

(57) ABSTRACT

The disposable pad with wipes for cleaning pet paws is a pad having packaged wipes attached thereto. Both pad and wipes are employed to clean the paws of a pet. The pad is fabricated from moisture-absorbent material with sealed edges and a liquid impervious rear surface to prevent leakage. A resealable container housing multiple individual wipes is integrally attached to the front surface of the pad. Both pad and wipes are fabricated from biodegradable material that can be easily and safely disposed of after use.

### BACKGROUND OF THE INVENTION

1. Field of the Invention

The present invention generally relates to accessories for pets. More specifically, the present invention is drawn to a disposable pad with wipes for cleaning pet paws.

2. Description of the Related Art

Pets love to play outdoors, even in inclement weather. However, the pet's paws are often dirty after playing outside on wet and muddy ground. If allowed inside, the pet will track water and mud over floors and carpet that may have been just cleaned and vacuumed. Furthermore, pets often step in feces of other pets or their own. Such feces can carry dangerous forms of bacteria (Ecoli, giardia, roundworms, salmonella, etc.). These bacteria pose dangerous health risks that can be deadly for children or persons with compromised immune systems. It would certainly be advantageous if there were a convenient and efficient accessory that would allow the pet's paws to be thoroughly cleaned before permitting free run of the inside of the room or home. Thus, a disposable pad with wipes for cleaning pet paws solving the aforementioned problems is desired.

### SUMMARY OF THE INVENTION

The disposable pad with wipes for cleaning pet paws is a pad having packaged wipes attached thereto. Both pad and wipes are employed to clean the paws of a pet. The pad is fabricated from moisture absorbent material with sealed edges and a liquid impervious rear surface to prevent leakage. A resealable container housing individual wipes is integrally attached to the front surface of the pad. The container houses multiple wipes. The wipes can be pre-moistened with a cleaning solution that is not harmful to humans or animals. The pad may measure approximately 28×35 inches, but could be fabricated in smaller or larger sizes, if desired. Both pad and wipes are fabricated from biodegradable material that can be easily and safely disposed of after use. The pad may be made available in multiple lots for the convenience of the consumer.

Although use as a pet accessory is indicated, it should be noted that the pad and wipe combination could have other uses, such as an infant changing accessory or use in hospitals and nursing homes, etc.

Accordingly, the invention presents a pad for efficiently and effectively cleaning pet paws. The pad is lightweight, highly portable and has a container of wipes integrally attached thereto. The pad and wipe can be conveniently disposed of after use without environmental concerns. The invention provides for improved elements thereof in an arrangement for the purposes described that are inexpensive, dependable and fully effective in accomplishing their intended purposes.

These and other features of the present invention will become readily apparent upon further review of the following specification and drawings.

### BRIEF DESCRIPTION OF THE DRAWINGS

FIG. 1 is an environmental, perspective view of a disposable pad with wipes for cleaning pet paws according to the present invention.

FIG. 2 is a plan view of a disposable pad with wipes for cleaning pet paws according to the present invention.

FIG. 3 is a partial sectional view of a disposable pad with wipes for cleaning pet paws according to the present invention.

FIG. 4 is an environmental perspective view showing disposal of a disposable pad with wipes for cleaning pet paws according to the present invention.

Similar reference characters denote corresponding features consistently throughout the attached drawings.

### DETAILED DESCRIPTION OF THE PREFERRED EMBODIMENT

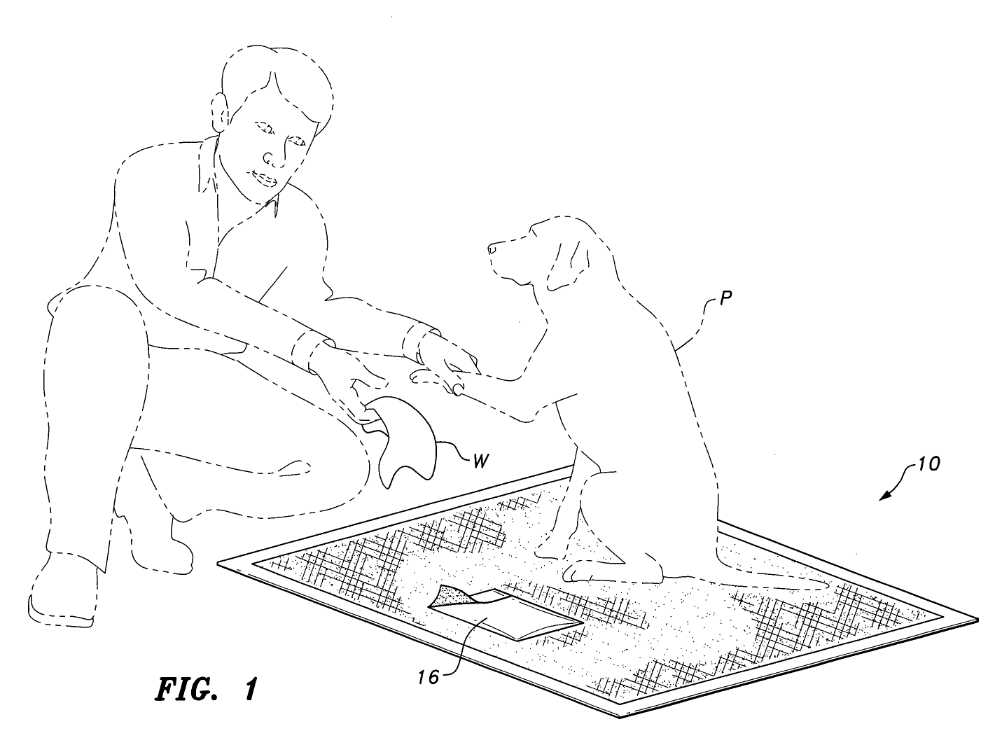

Attention is directed to FIG. 1 wherein the pad of the present invention is generally indicated at 10. As illustrated the pad is positioned on a level surface so that a pet P can clean its paws thereon. A wipe W is retrieved from container 16 for further cleaning of the paw(s) as necessary. As noted above, the wipes can be pre-moistened to enhance their effectiveness.

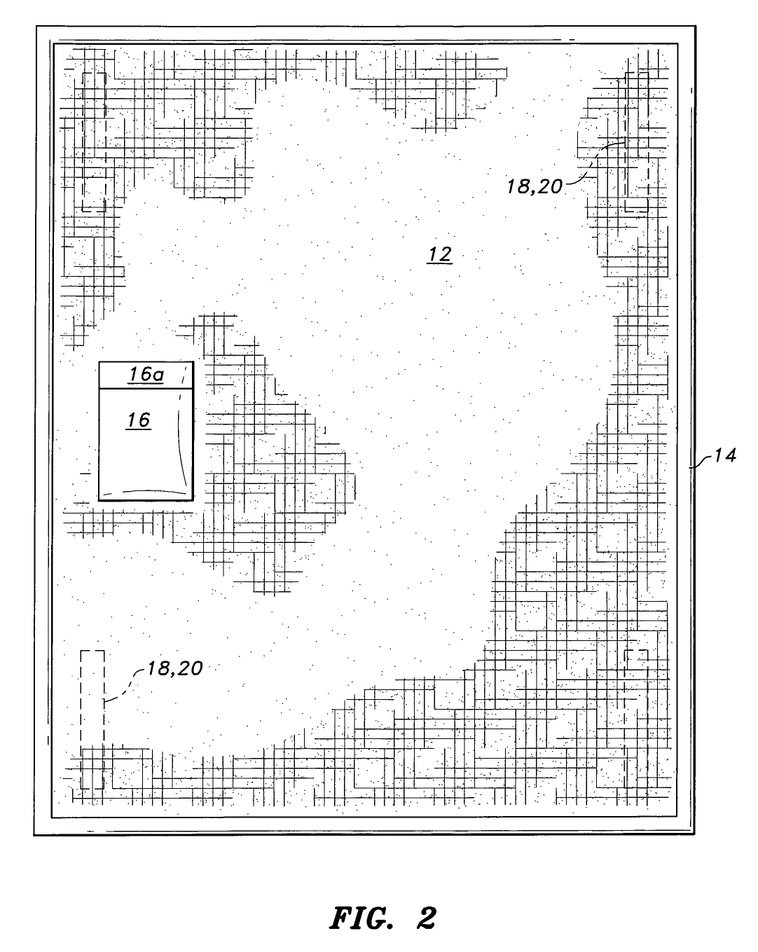

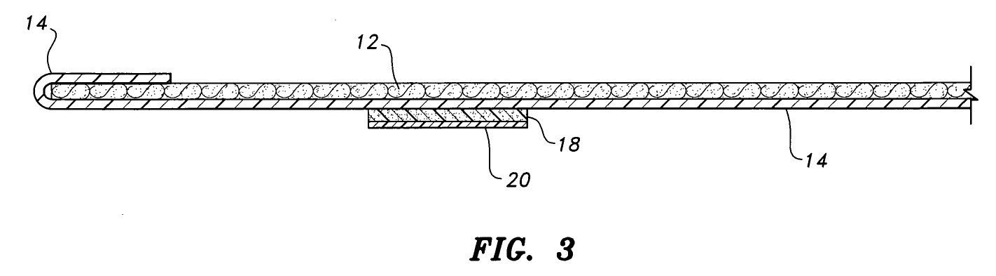

As best seen in FIGS. 2 and 3, pad 10 comprises a sheet 12 fabricated from a flexible, moisture absorbent material. Sheet 12 is encompassed along its edges and entire undersurface with a liquid impervious barrier 14. This arrangement will prevent any moisture accumulated in sheet 12 from seeping through to the pad-supporting surface. A container 16, having an opening with a resealable flap 16a or the like, is attached in integral relationship to the upper surface of sheet 12. Container 16 houses a quantity of wipes therein. Feet 18 made from adhesive material are strategically attached to the outer surface of barrier 14 to enhance the stability of the pad when positioned on a supporting surface. Release paper 20 covers feet 18 and is removable to expose the feet when the pad is to be used.

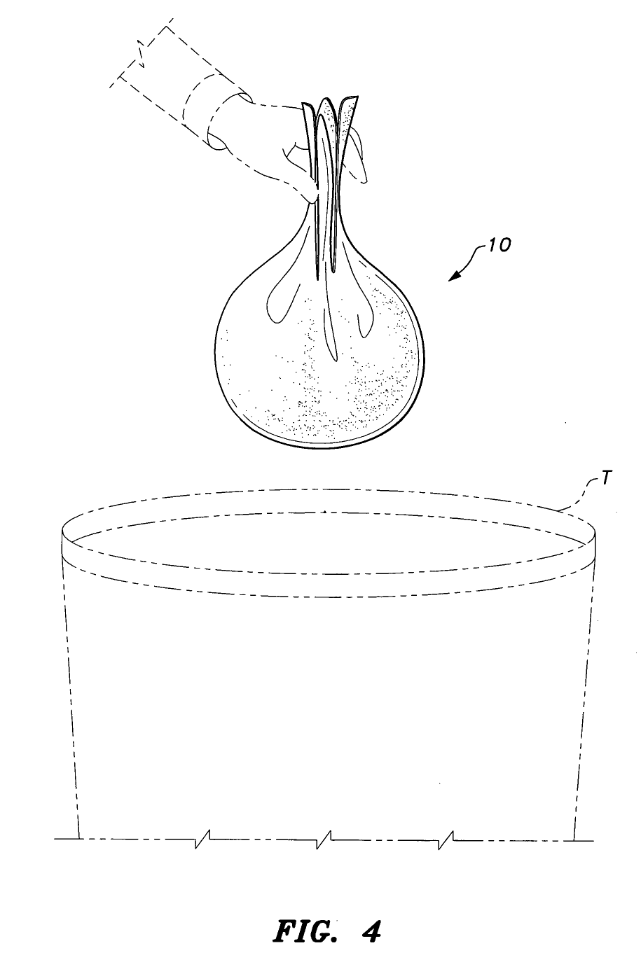

All materials are fabricated from biodegradable material that can easily and safely be disposed of in a trash vessel T after use (FIG. 4).

It is to be understood that the present invention is not limited to the embodiment described above, but encompasses any and all embodiments within the scope of the following claims.

We claim:

1. A disposable pad with wipes for cleaning pet paws, comprising:
a pad made from a moisture-absorbing material and having a planar upper surface and a planar undersurface;
a container integrally attached to the upper planar surface of the pad; and
a plurality of wipes housed in the container.

2. The disposable pad according to claim 1, wherein said container has a resealable opening.

3. The disposable pad according to claim 1, wherein said pad and said container are made from biodegradable material.

4. The disposable pad according to claim 1, further including a liquid impervious barrier encompassing said planar undersurface.

5. The disposable pad according to claim 1, wherein said plurality of wipes comprises a plurality of pre-moistened wipes.

6. A disposable pad with wipes for cleaning pet paws, comprising:
a pad made from a flexible, moisture absorbing material, the pad having edges, a planar upper surface and a planar undersurface;
a container integrally attached to the upper planar surface of the pad; and
a plurality of pre-moistened wipes housed in the container.

7. The disposable pad according to claim 6, further including a liquid impervious barrier encompassing said edges and said planar undersurface.

8. The disposable pad according to claim 6, wherein said container has a resealable opening.

9. The disposable pad according to claim 6, wherein said pad and said container are made from biodegradable material.

10. A disposable pad with wipes for cleaning pet paws, comprising:
a pad made from a flexible, moisture absorbing material, the pad having edges, a planar upper surface and a planar undersurface;
a liquid impervious barrier encompassing the edges and the planar undersurface;
a container integrally attached to the upper planar surface of the pad, the container having a resealable opening; and
a plurality of pre-moistened wipes housed in the container.

11. The disposable pad according to claim 10, further including a plurality of adhesive feet disposed on said liquid impervious barrier and a removable release paper covering the adhesive feet.

12. The disposable pad according to claim 10, further including a plurality of adhesive feet disposed on said liquid impervious barrier and a removable release paper covering the adhesive feet, said pad, said container, said liquid impervious barrier, said adhesive feet and said release paper being made from biodegradable material.
